(19) United States
(12) Patent Application Publication
(10) Pub. No.: US 2023/0323679 A1
(43) Pub. Date: Oct. 12, 2023

(54) DECORATIVE COVER FOR ELECTRICAL WALLPLATES

(71) Applicant: Neal Patrick Ferris, Charlotte, NC (US)

(72) Inventor: Neal Patrick Ferris, Charlotte, NC (US)

(21) Appl. No.: 18/131,005

(22) Filed: Apr. 5, 2023

Related U.S. Application Data
(60) Provisional application No. 63/328,371, filed on Apr. 7, 2022.

(51) Int. Cl. E04F 19/02; H01R 13/447

(52) U.S. Cl. CPC E04F 19/02; H01R 13/447

(57) ABSTRACT

A cover apparatus is adapted for releasable attachment to an electrical wallplate. The cover apparatus can have decorative surface ornamentation, such as various graphic designs and/or colors, such that the cover apparatus provides ornamental decoration enhancing the appearance of the wallplate. In a particular embodiment for use with magnetic wallplates, the cover apparatus can be comprised of a material having magnetic properties whereby the cover apparatus is magnetically attached to the wallplate.

### CROSS REFERENCE TO RELATED APPLICATIONS

This application claims priority to U.S. Provisional Patent Application No. 63/328,371, filed Apr. 7, 2022, which is incorporated herein by reference.

### TECHNICAL FIELD

The present invention relates to home décor, in particular decorative items for use with wallplates for electrical switches and outlets. One embodiment of the invention comprises a decorative cover that can be releasably attached to an electrical switch wallplate.

### BACKGROUND

Wallplates, also known as “switch plates” and “face plates”, are known and widely used to provide a protective covering over an electrical switch or outlet. For example, U.S. Pat. No. 4,009,797, which is incorporated herein by reference, discloses a wall plate for electrical switches, electrical outlets and the like. Wallplates are typically made of metal or plastic, and typically are a single basic color such as white, gray, gold, silver, or black.

### SUMMARY

One object of the present invention is to provide a method for providing ornamental decoration to the wallplate of an electrical switch or outlet. Another object of the invention is to provide an apparatus that decorates the wallplate of an electrical switch or outlet. These and other objects of the invention can be achieved in various embodiments of the invention described herein.

An embodiment of the invention comprises a cover apparatus adapted for releasable attachment to an electrical wallplate. The cover apparatus can have decorative surface ornamentation, such as various graphic designs and/or colors, whereby the cover apparatus provides ornamental decoration enhancing the appearance of the wallplate. In addition, the cover apparatus can conceal unsightly fasteners such as screws and/or screw holes positioned through the electrical wallplate.

One embodiment of the invention comprises a cover apparatus adapted to cover an electrical wallplate comprised of metal. The cover can be shaped and sized to cover the wall plate and can be comprised of a material having magnetic properties whereby the cover member is magnetically attached to the wallplate.

According to an embodiment of the invention, the cover apparatus can be comprised of ceramic ferrite, samarium cobalt, neodymium and/or alnico.

According to an embodiment of the invention, the cover apparatus has an opening formed therethrough. The opening can be sized and positioned to receive an electrical switch therethrough. Alternatively, the opening can be sized and positioned to expose an electrical outlet.

According to another embodiment of the invention, the cover apparatus comprises a printed magnetic sheet having decorative surface ornamentation, such as a graphic design, logo and/or colors. According to another embodiment of the invention, the decorative surface ornamentation can be a digital photograph.

An embodiment of the invention comprises a cover apparatus for decorating an electrical wallplate comprised of magnetic material. The apparatus comprises a generally planar cover member having decorative surface ornamentation and at least one opening formed therein. The cover member is comprised of a material having magnetic properties whereby the planar member can be releasably attached to the electrical wallplate by magnetic attraction between planar member and the electrical wallplate.

According to an embodiment of the invention, the opening formed in the cover member is sized and shaped and positioned on the cover member to receive an electrical switch therethrough when the cover member is attached to the electrical wallplate.

According to another embodiment of the invention, the opening formed in the cover member is adapted to receive an electrical toggle switch therethrough.

According to another embodiment of the invention, the opening formed in the cover member is adapted to receive an electrical rocker switch therethrough.

According to another embodiment of the invention, first and second openings are formed in the cover member and are adapted to receive first and second electrical switches therethrough.

According to another embodiment of the invention, the cover member is substantially rectangular, and the opening formed in the cover member is substantially rectangular and positioned proximate the center of the cover member.

According to another embodiment of the invention, the opening formed in the cover member is sized and shaped to conform to a size and shape of an electrical outlet.

According to another embodiment of the invention, a first opening is formed in the cover member and is adapted to expose a first electrical outlet, and a second opening is formed in the cover member and is adapted to expose a second electrical outlet.

According to another embodiment of the invention, the material having magnetic properties can be ceramic ferrite, samarium cobalt, neodymium and alnico.

According to another embodiment of the invention, the cover member comprises a polymer mixed with ferrite powder laminated with polyvinyl chloride.

According to another embodiment of the invention, the decorative surface ornamentation can be a graphic design, a photographic image, and/or a logo.

Another embodiment of the invention comprises a kit for decorating an electrical wallplate comprised of a non-magnetic material comprising a cover member and an attachment member. The cover member has decorative surface ornamentation and at least one opening formed therein. The cover member and the attachment member are comprised of material(s) having magnetic properties, such that the attachment member is magnetically attracted to the cover member. The attachment member includes attachment means for attaching the attachment member to the electrical wallplate, whereby the attachment member can be attached to the electrical wallplate and the cover member can be magnetically attached to the attachment member. According to an embodiment of the invention, the attachment means can be adhesive. According to another embodiment of the invention, the opening formed in the cover member receives an electrical switch therethrough.

Another embodiment of the invention comprises a method for decorating an electrical wallplate comprised of magnetic material(s). The method comprises providing a kit comprising a plurality of cover members. Each cover member has an opening formed therein for receiving an electrical switch therethrough and is comprised of a material having magnetic properties. Each cover member can have a distinctive decorative surface ornamentation. For example, a first cover member has a first decorative surface ornamentation, and a second cover member has a second decorative surface ornamentation distinct from the first decorative surface ornamentation. The first cover member can be positioned on the electrical wallplate such that the first cover member is releasably attached to the electrical wallplate by magnetic attraction between first cover member and the electrical wallplate.

According to another embodiment of the invention, the first cover member can be removed from the electrical wallplate, and the second cover member is positioned on the electrical wallplate whereby the second cover member is releasably attached to the electrical wallplate by magnetic attraction between second cover member and the electrical wallplate.

### BRIEF DESCRIPTION OF THE DRAWINGS

FIG. 1 is a top plan view of a cover apparatus according to an embodiment of the invention;

FIG. 2 is another top plan view of the cover apparatus of FIG. 1;

FIG. 3 is a top plan view of kit according to another embodiment of the invention;

FIG. 4 is a top plan view of a cover apparatus according to another embodiment of the invention;

FIG. 5 is a top plan view of a cover apparatus according to another embodiment of the invention;

FIG. 6 is a top plan view of a cover apparatus according to another embodiment of the invention;

FIG. 7 is a top plan view of a cover apparatus according to another embodiment of the invention;

FIG. 8 is a top plan view of a kit according to another embodiment of the invention;

FIG. 9 is a partial environmental view of the kit of FIG. 8;

FIG. 10 is another environmental view of the kit of FIG. 8;

FIG. 11 is another partial environmental view of the kit of FIG. 8; and

FIG. 12 is a top plan view of a kit according to another embodiment of the invention.

### DETAILED DESCRIPTION OF PREFERRED EMBODIMENTS

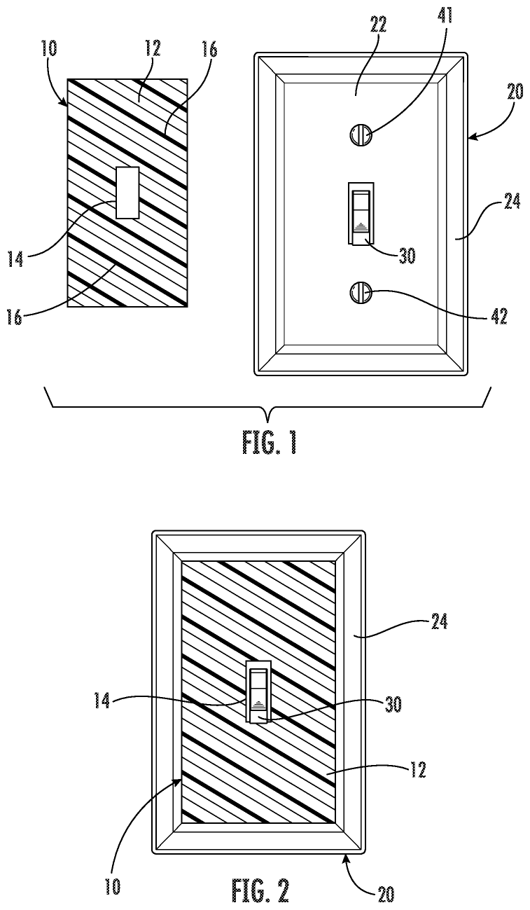

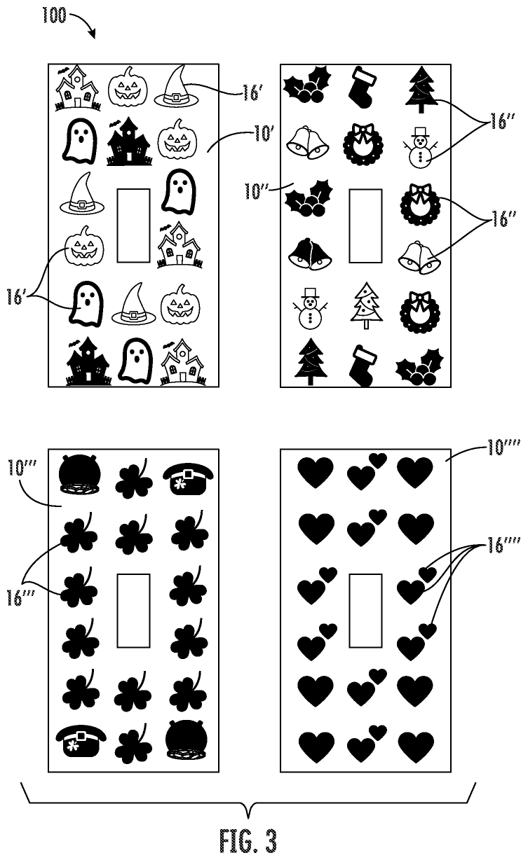

A cover apparatus according to a preferred embodiment of the invention is illustrated in FIGS. 1-2 and shown generally at reference numeral 10. The cover 10 comprises a substantially rectangular and planar cover member 12. A substantially rectangular opening 14 is formed in the center of the planar member 12, as shown in FIG. 1.

The cover member 12 is made of a material having magnetic properties. The cover member 12 can be comprised of a magnetic material, such as ceramic ferrite, samarium cobalt, neodymium or alnico.

The cover 10 is adapted for use with a metal wallplate 20 for an electrical toggle-type switch 30. The wallplate 20 can be made of metal, such as stainless steel. In a method of using the cover 10, the cover member 12 is positioned on the wallplate 20 with the electrical switch 30 received through the cover opening 14, as shown in FIG. 2. The wallplate 20 can include a depressed inset portion 22 and a convex border portion 24 extending along the outer perimeter of the wallplate 20, as shown in FIG. 1. The cover member 12 can be sized and shaped to sit within the inset portion 22, as shown in FIG. 2. The magnetic cover member 12 is magnetically attracted to the metal wallplate 20. The cover 10 and the wallplate 20 are releasably attached via the magnetic attraction. When desired, the cover 10 can be easily removed from the wallplate 20 by grasping a corner of the cover member 12 and pulling the cover member 12 off of the wallplate 20. According to an embodiment, the corners of the cover member 12 can be rounded to facilitate peeling of the cover member 12 off of the wallplate 20.

The cover member 12 can have various decorative surface ornamentation. For example, the cover member 12 can have surface ornamentation comprising diagonal stripes 16, as shown in FIGS. 1 and 2. When attached to the wallplate 20, the cover 10 provides a desired decorative ornamentation on the electrical wallplate 20, as shown in FIG. 2. In addition, the cover apparatus 10 conceals unsightly screws 41, 42 positioned through the wallplate 20.

The cover member 12 can be comprised of a layer of a polymer mixed with ferrite powder to provide magnetic properties, which is laminated with white polyvinyl chloride (PVC) to provide the decorative surface ornamentation. The polymeric layer can be cut to the desired size and shape, and a second layer having decorative ornamentation can be adhered to the polymeric layer.

According to a preferred embodiment, a method of making the cover apparatus 10 comprises providing a flexible magnetic sheet having a printable laminate layer as described in U.S. Pat. No. 8,440,128, which is incorporated herein by reference. The flexible magnetic is cut into a substantially rectangular shaped cover member 12 having a length and width to sit within the inset portion 22 of the electrical wallplate, as shown in FIG. 2. The rectangular opening 14 is cut in the center of the cover member 12. The printable laminate layer provides the decorative surface ornamentation 16.

In another embodiment, the cover apparatus 10 can be made from a flexible magnetic sheet that is digitally printable on both sides, described in U.S. Pat. No. 9,440,480, which is incorporated herein by reference. A first decorative design can be printed on one side of the flexible magnetic sheet, and second decorative design distinct from the first design can be printed on the opposite side of the flexible magnetic sheet. As such, the cover apparatus 10 can, for example, have a holiday design such as a Thanksgiving themed design on one side, and a different holiday design such as a Christmas themed design on the opposite side. In November, the user can apply the cover apparatus 10 to the wallplate 20 with the Thanksgiving side facing outward, and when Thanksgiving has passed, the user can remove the cover apparatus 10 from the wallplate 20 and put it back on the wallplate 20 with the Christmas side facing outward.

As noted above, the cover member 12 can have any variety of surface ornamentation and it is not limited to the specific design shown at reference numeral 16 in FIG. 3. According to an embodiment, the surface ornamentation can be a photographic image. In a preferred embodiment, the surface ornamentation can be customized for a particular user. An image of a photograph taken by the user can be applied to the cover member 12. U.S. Pat. No. 9,462,093 discloses various devices and methods for personalizing the appearance of a consumer product and is incorporated herein by reference.

Another embodiment of the invention comprises a kit 100 comprising a plurality of covers 10′, 10″, 10′″, 10″″, with each cover 10′, 10″, 10′″, 10″″ having different decorative surface ornamentation 16′, 16″, 16′″, 16″″. As shown in FIG. 3, the kit 100 can comprise four covers 10′, 10″, 10′″, 10″″, with each cover having surface ornamentation relating to a particular holiday. For example, a first cover 10′ can have surface ornamentation 16′ relating to Halloween, a second cover 10″ can have surface ornamentation 16″ relating to Christmas, a third cover 10′″ can have surface ornamentation 16′″ relating to St. Patrick's Day, and a fourth cover 10″″ can have surface ornamentation 16″″ relating to Valentine's Day, as shown in FIG. 3. As such, a user can change the decorative appearance of the wallplate whenever desired by removing one cover and replacing it with another. For example, the user can attach the Halloween themed cover 10′ on his/her wallplate in the month of October, and in November the user can remove the Halloween cover 10′ from his/her wallplate and replace it with the Christmas themed cover 10″. The kit 100 is not limited to the particular holiday designs depicted in FIG. 3, and can include covers having any variety of decorative surface ornamentation.

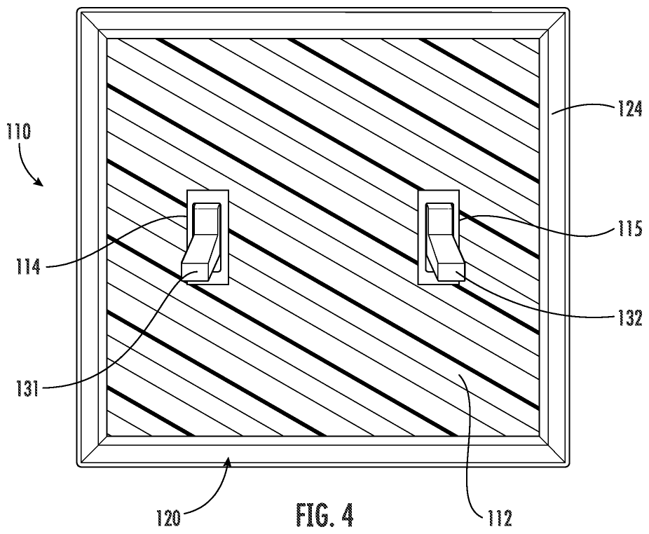

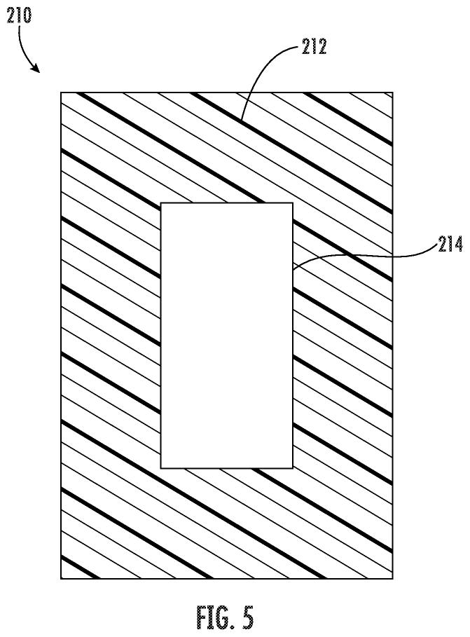

Embodiments of the invention include various covers adapted for use with various configurations of electrical wallplates. For example, a cover apparatus according to another embodiment is illustrated in FIG. 4 and shown generally at reference numeral 110. The cover apparatus 110 is adapted for use with a wall plate 120 for an electrical outlet having two toggle switches 131, 132.

The cover 110 comprises a rectangular cover member 112 comprised of a magnetic material, such as ceramic ferrite, samarium cobalt, neodymium or alnico, and the wallplate 120 can be made of metal, such as stainless steel. The cover member 112 is positioned on the wallplate 120 with the electrical switch 131, 132 received through cover openings 114, 115 as shown in FIG. 4. The wallplate 120 can include a depressed inset portion and a convex border portion 124 extending along the outer perimeter of the wallplate 120. The cover member 112 can be sized and shaped to sit within the inset portion of the wallplate 120, as shown in FIG. 4.

Embodiments of the invention include covers adapted for use with other configurations of electrical outlet wallplates. For example, an embodiment of the invention comprises a cover apparatus comprising a rectangular cover member having three openings adapted for use with wallplates for outlets having three toggle switches. Another embodiment of the invention comprises a cover apparatus comprising a rectangular cover member having four openings adapted for use with wallplates for outlets having four toggle switches. Yet another embodiment of the invention comprises a cover apparatus comprising a rectangular cover member having five openings adapted for use with wallplates for outlets having five toggle switches.

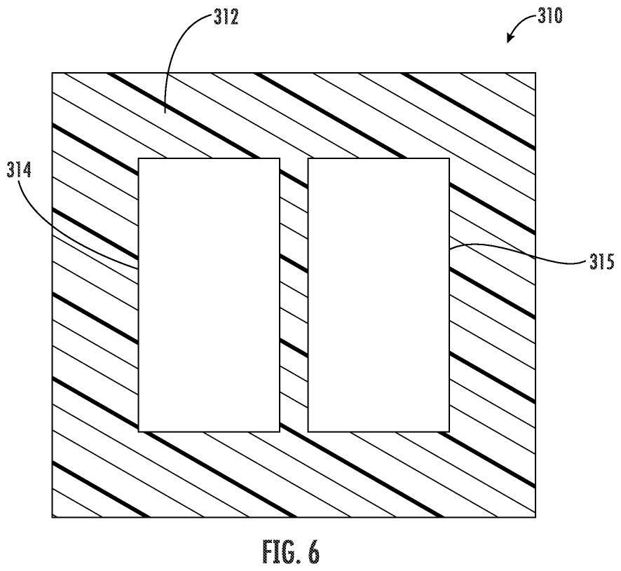

FIG. 5 illustrates another embodiment of the invention comprising a cover apparatus 210 adapted for use with wallplates for electrical outlets with rocker type switches. The cover 210 apparatus comprises a cover member 212 having a larger rectangular 214 opening sized and shaped to accommodate a rocker switch. Another embodiment of the invention is a cover apparatus 310 adapted for use with wallplates for outlets having two rocker switches, as shown in FIG. 6. The cover apparatus 310 comprises a rectangular cover member 314 having two openings 314, 315 positioned, sized and shaped for use with wallplates for outlets having two rocker switches. In another embodiment of the invention, a cover apparatus comprises a rectangular cover member having three openings for accommodating three rocker switches. Yet another embodiment of the invention comprises a cover apparatus comprising a rectangular cover member having four openings adapted for use with wallplates for outlets having four rocker switches. Another embodiment of the invention comprises a cover apparatus comprising a rectangular cover member having five openings adapted to accommodate five rocker switches.

Another embodiment of the invention comprises a cover apparatus adapted for use with a wallplate accommodating a toggle switch and a rocker switch. The cover apparatus comprises a cover member having a first opening sized and shaped to receive a toggle switch therethrough and a second opening sized and shaped to receive a rocker switch therethrough. Another embodiment of the invention can comprise a cover apparatus adapted for use with two toggle switches and a single rocker switch.

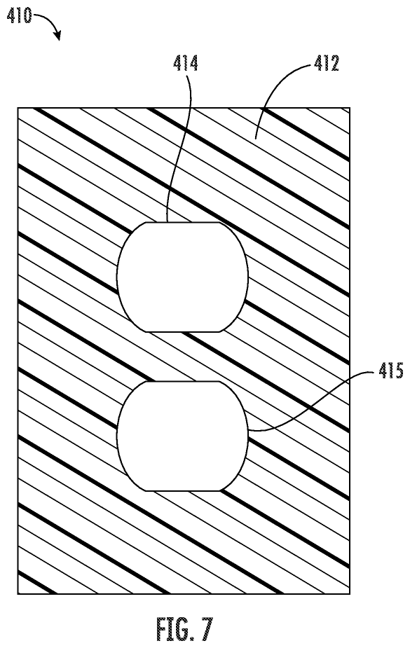

A cover apparatus according to another embodiment of the invention is illustrated in FIG. 7 and shown generally at reference numeral 410. The cover apparatus 410 is adapted for use with a single duplex outlets wallplate. The cover apparatus 410 comprises a cover member 412 having two openings 414, 415 that are positioned, sized and shaped to conform to the position, size and shape of standard duplex outlets. Another embodiment of the invention comprises a cover apparatus adapted for use with a two duplex outlets wallplate.

Another embodiment of the invention comprises a kit for use with non-metal wallplates, such as wallplates made of plastics. The wallplates can be made of non-metal material such as thermoplastic nylon, polyvinyl chloride (PVC), polypropylene (PP) and/or polyethylene (PE). The kit comprises a cover apparatus and means for releasably positioning the cover apparatus on a non-metal wallplate. The means for releasably positioning the cover apparatus to a non-metal wallplate can comprise one or more universal mount metal plates that can be adhered to the wallplate. Alternatively, the means for releasably positioning the cover apparatus to a non-metal wallplate can comprise hook and loop (VELCRO) fasteners.

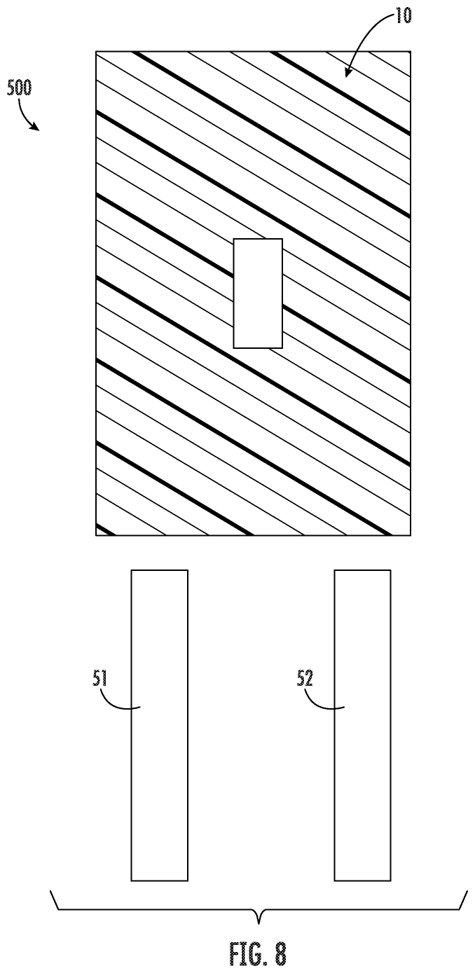

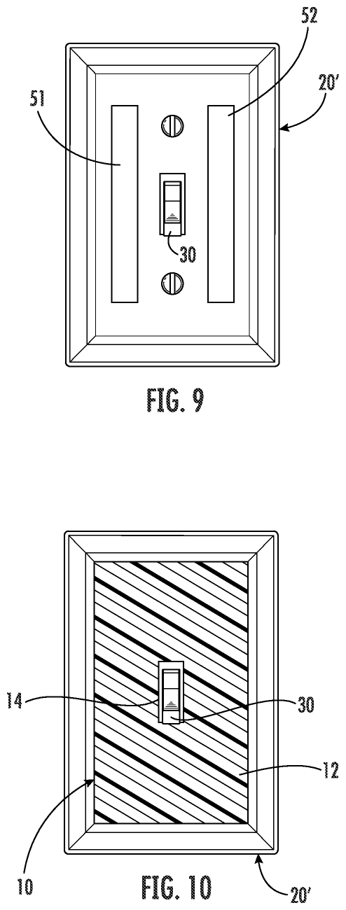

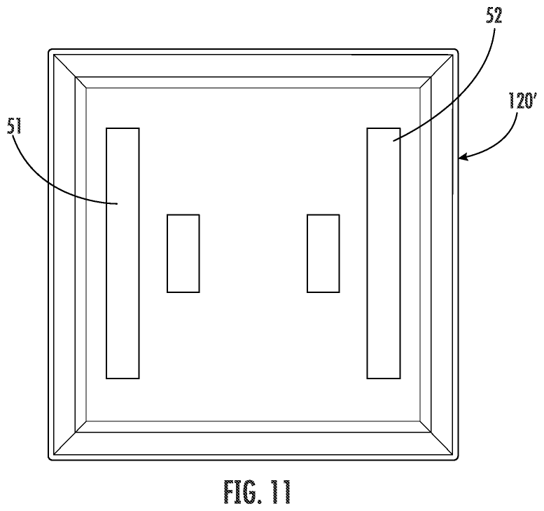

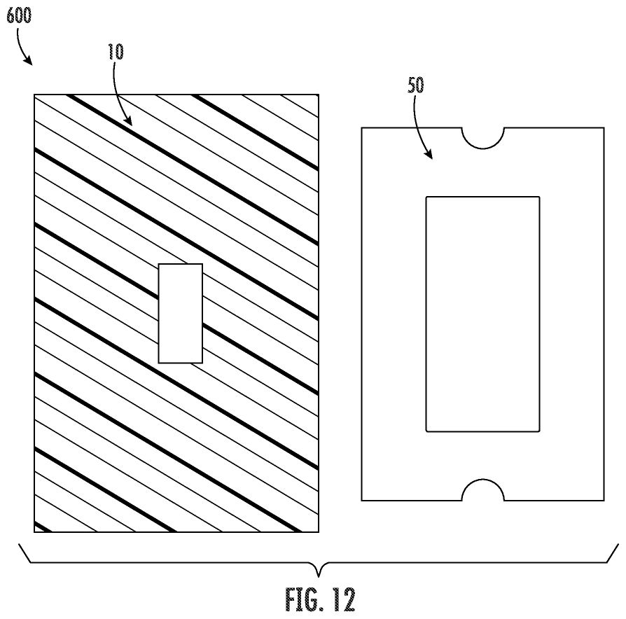

A kit according to an embodiment of the invention is illustrated in FIG. 8 and shown generally at reference numeral 500. The kit 500 can comprise the cover apparatus 10 and a pair of universal mount ultra-thin metal plates 51, 52. Each plate 51, 52 has adhesive on the back so that the plates 51, 52 can be adhered to a non-metal wallplate 20′, as shown in FIG. 9. After the metal plates 51, 52 are adhered to the wallplate 20′, the cover 10 can be positioned on the plates 51, 52 and the cover 10 is releasably attached thereto via the magnetic attraction between the cover 10 and the metal plates 51, 52, as shown in FIG. 10. As such, the magnetic cover apparatus 10 can be used with non-metal wallplates. In another embodiment, the metal plates 51, 52 can be adhered to a non-metal double toggle switch wallplate 120′, as shown in FIG. 11, and cover apparatus 110 can be releasably attached to the plates 51, 52 via magnetic attraction.

A kit according to another embodiment of the invention is illustrated in FIG. 12 and shown generally at reference numeral 600. The kit 600 comprises the magnetic cover apparatus 10 and an attachment member 50. The attachment member 50 is comprised of a material having magnetic properties such that it is magnetically attracted to the magnetic cover apparatus 10. An adhesive covers the back side of the attachment member 50. A peelable plastic layer can cover the adhesive on the back side of the attachment member 50. When ready to be used, the plastic layer is peeled away and the back side of the attachment member is pressed upon a non-metal wall plate 20′. The attachment member is adhered to the wall plate 20′. The cover apparatus 10 can be positioned on the attachment member and the cover apparatus 10 and attachment member 50 are releasably attached to each other via the magnetic attraction.

A cover apparatus and method of using same are described above. Various changes can be made to the invention without departing from its scope. The above description of various embodiments of the invention are provided for the purpose of illustration only and not limitation—the invention being defined by the claims and equivalents thereof.

What is claimed is:

1. A cover apparatus for decorating an electrical wallplate comprised of magnetic material, comprising a cover member having decorative surface ornamentation and at least one opening formed therein, the cover member comprised of a material having magnetic properties whereby the cover member can be releasably attached to the electrical wallplate by magnetic attraction between cover member and the electrical wallplate.

2. The cover apparatus according to claim 1, wherein the at least one opening is adapted to receive an electrical switch therethrough.

3. The cover apparatus according to claim 1, wherein the at least one opening is sized and shaped and positioned on the cover member to receive an electrical switch therethrough when the cover member is attached to the electrical wallplate.

4. The cover apparatus according to claim 3, wherein the electrical switch comprises an electrical toggle switch.

5. The cover apparatus according to claim 3, wherein the electrical switch comprises an electrical rocker switch.

6. The cover apparatus according to claim 1, wherein the at least one opening comprises a first opening adapted to receive a first electrical switch therethrough and a second opening adapted to receive a second electrical switch therethrough.

7. The cover apparatus according to claim 6, wherein the first electrical switch and the second electrical switch are selected from the group consisting of an electrical toggle switch and an electrical rocker switch.

8. The cover apparatus according to claim 1, wherein the cover member is substantially rectangular, and the at least one opening is substantially rectangular and positioned proximate a center of the cover member.

9. The cover apparatus according to claim 1, wherein the at least one opening is sized and shaped to conform to a size and shape of an electrical outlet.

10. The cover apparatus according to claim 9, wherein the at least one opening comprises a first opening adapted to expose a first electrical outlet and a second opening adapted to expose a second electrical outlet.

11. The cover apparatus according to claim 1, wherein the material having magnetic properties is selected from the group consisting of ceramic ferrite, samarium cobalt, neodymium and alnico.

12. The cover apparatus according to claim 1, wherein the cover member comprises a polymer mixed with ferrite powder laminated with polyvinyl chloride.

13. The cover apparatus according to claim 1, wherein the decorative surface ornamentation comprises at least one selected from the group consisting of a graphic design, a photographic image, and a logo.

14. A kit for decorating an electrical wallplate comprised of a non-magnetic material comprising:
(a) a cover member having decorative surface ornamentation and at least one opening formed therein, the cover member comprised of a material having magnetic properties; and
(b) at least one attachment member comprised of a material having magnetic properties whereby the at least one attachment member is magnetically attracted to the cover member, the at least one attachment member further comprising attachment means for attaching the attachment member to the non-magnetic electrical wallplate, whereby the attachment member can be attached to the electrical wallplate and the cover member can be magnetically attached to the attachment member.

15. The kit according to claim 14, wherein the attachment means comprises an adhesive.

16. The kit according to claim 14, wherein the at least one opening is adapted to receive an electrical switch therethrough.

17. The kit according to claim 14, wherein the at least one opening is sized and shaped and positioned on the cover member to receive an electrical switch therethrough when the cover member is attached to the electrical wallplate.

18. The kit according to claim 14, wherein the cover member comprises a polymer mixed with ferrite powder laminated with polyvinyl chloride.

19. A method for decorating an electrical wallplate comprised of magnetic material, comprising:
(a) providing a kit comprising a first cover member and a second cover member, each of the first cover member and the second cover member having an opening formed therein for receiving an electrical switch therethrough and comprised of a material having magnetic properties, the first cover member having a first decorative surface ornamentation and the second cover member having a second decorative surface ornamentation distinct from the first decorative surface ornamentation; and
(b) positioning the first cover member on the electrical wallplate whereby the first cover member is releasably attached to the electrical wallplate by magnetic attraction between first cover member and the electrical wallplate.

20. The method according to claim 19, further comprising:
(a) removing the first cover member from the electrical wallplate; and
(b) positioning the second cover member on the electrical wallplate whereby the second cover member is releasably attached to the electrical wallplate by magnetic attraction between second cover member and the electrical wallplate.
